(19) United States
(12) Patent Application Publication
(10) Pub. No.: US 2018/0122051 A1
(43) Pub. Date: May 3, 2018

(54) METHOD AND DEVICE FOR IMAGE HAZE REMOVAL

(71) Applicant: Agency for Science, Technology and Research, Singapore (SG)

(72) Inventors: Zhengguo Li, Singapore (SG); Jinghong Zheng, Singapore (SG)

(21) Appl. No.: 15/563,454

(22) PCT Filed: Mar. 30, 2016
(86) PCT No.: PCT/SG2016/050157

§ 371 Date: Sep. 29, 2017

(30) Foreign Application Priority Data
Mar. 30, 2015 (SG) 10201502507X

(51) Int. Cl. G06T 5/00; G06T 5/40; G06T 5/20

(52) U.S. Cl. CPC G06T 5/003; G06T 2207/20192; G06T 5/20; G06T 5/40

(57) ABSTRACT

Various embodiments provide a method of processing an input image to generate a de-hazed image. The method may include determining an atmospheric light based on the input image; determining a medium transmission map by applying an edge-preserving smoothing filter to the input image; and recovering scene radiances of the input image based on the determined atmospheric light and the determined medium transmission map. The recovered scene radiances form the de-hazed image.

### CROSS-REFERENCE TO RELATED APPLICATIONS

The present application claims the benefit of the Singapore patent application 10201502507X filed on 30 Mar. 2015, the entire contents of which are incorporated herein by reference for all purposes.

### TECHNICAL FIELD

Embodiments generally relate to methods and devices for image processing. Specifically, embodiments relate to methods and devices for image haze removal.

### BACKGROUND

Images of outdoor scenes often suffer from bad weather conditions such as haze, fog, smoke and so on. The light is scattered and absorbed by the aerosols in the atmosphere, and it is also blended with air-light reflected from other directions. This process fades the colour and reduces the contrast of captured objects, and the degraded images often lack visual vividness. Haze removal can significantly increase both local and global contrast of the scene, correct the colour distortion caused by the airlight, and produce depth information. As such, the de-hazed image is usually more visually pleasuring. The performance of computer vision methods and advanced image editing methods can also be improved. Therefore, haze removal is highly demanded in image processing, computational photography and computer vision applications.

Since the amount of scattering depends on the unknown distances of the scene points from the camera and the air-light is also unknown, it is challenging to remove haze from haze images, especially when there is only a single haze image. Recently, haze removal through single image attracted much interest and made significant progresses due to its broad applications. Many single image haze removal methods were proposed. The success of these methods lies in utilization of a strong prior or assumption. Based on an observation that a haze-free image has higher contrast than its haze image, conventional single image haze removal is done by maximizing the local contrast of the restored image. The results are visually compelling while they might not be physically valid. A haze image can be interpreted through a refined image formation model that accounts for both surface shading and scene transmission. Under an assumption that the transmission and the surface shading are locally uncorrelated, the air-light-albedo ambiguity is resolved. The technique sounds reasonable from the physical point of view and it can also produce satisfactory results. However, this method could fail in presence of heavy haze. A dark channel prior based haze removal method has been proposed where the dark channel prior is based on an observation of haze-free outdoor images, i.e., in most of the local regions which do not cover the sky, it is very often that some pixels have very low intensity in at least one colour (RGB) channel. The method is physically valid and can handle distant objects even in images with heavy haze. However, noise in the sky could be amplified and colour in brightest regions could be distorted even though a lower bound was introduced for the transmission map. The dark channel prior was simplified by introducing a minimal colour component for a haze image. A non-negative sky region compensation term was also proposed to avoid the amplification of noise in the sky region. Each of the above single image haze removal methods is based on a strong prior or assumption and the assumption may not hold true. It is needed to avoid a prior or assumption from being used in a haze removal method.

### SUMMARY

Various embodiments provide a method of processing an input image to generate a de-hazed image. The method may include determining an atmospheric light based on the input image; determining a medium transmission map by applying an edge-preserving smoothing filter to the input image; and recovering scene radiances of the input image based on the determined atmospheric light and the determined medium transmission map. The recovered scene radiances form the de-hazed image.

Various embodiments provide an image processing device. The image processing device may include an atmospheric light determiner configured to determine an atmospheric light based on the input image, a medium transmission map determiner configured to determine a medium transmission map by applying an edge-preserving smoothing filter to the input image, and a de-hazed image generator configured to recover scene radiances of the input image based on the determined atmospheric light and the determined medium transmission map. The recovered scene radiances form the de-hazed image.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a flowchart illustrating a method of processing an input image according to various embodiments.

FIG. 2 shows a flowchart illustrating a method of processing an input image according to various embodiments.

FIG. 3 shows a schematic diagram of an image processing device according to various embodiments.

FIG. 4 shows a schematic diagram of an image processing device according to various embodiments.

### DESCRIPTION

Various embodiments provide an image haze removal method by introducing an edge-preserving decomposition technique for a haze image. The haze removal method of various embodiments can avoid or reduce halo artifacts, noise in the bright regions, and colour distortion from appearing in the de-hazed image. In addition, a very small amount of haze is retained for the distant objects by the haze removal method of the embodiments. As a result, the perception of distance in the de-hazed image could be preserved better. Experimental results show that the method of various embodiments can be applied to achieve better image quality, and is also friendly to mobile devices with limited computational resource.

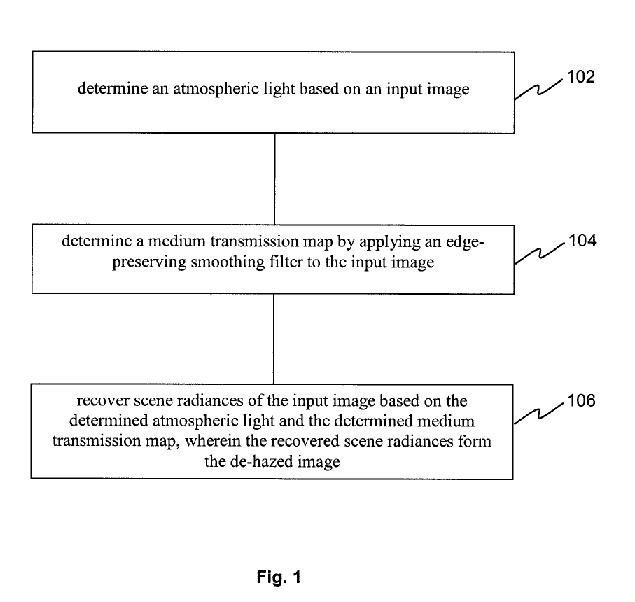

FIG. 1 shows a flowchart illustrating a method of processing an input image to generate a de-hazed image according to various embodiments.

At 102, an atmospheric light is determined based on the input image.

At 104, a medium transmission map is determined by applying an edge-preserving smoothing filter to the input image.

At 106, scene radiances of the input image are recovered based on the determined atmospheric light and the determined medium transmission map. The recovered scene radiances form the de-hazed image.

In various embodiments, the edge-preserving smoothing filter may include one of a guided image filter (GIF), a weighted guided image filter (WGIF), a gradient domain guided image filter or a bilateral filter (BF).

In various embodiments, the medium transmission map may be determined, including determining dark channels of the input image; determining a base layer of the input image from the dark channels using the edge-preserving smoothing filter; and determining the medium transmission map based on the base layer.

In various embodiments, the determination of the dark channels of the input image may include, for each pixel of the input image, determining minimal intensity color components of pixels in a predetermined neighborhood of the pixel, and determining the dark channel of the pixel to be a minimum intensity among the determined minimal intensity color components.

In various embodiments, the base layer may be determined by determining a plurality of coefficients using the edge-preserving smoothing filter; and determining the base layer of the input image based on the dark channels of the input image, the plurality of coefficients and the determined atmospheric light.

In various embodiments, the medium transmission map may be derived from the base layer, for example, using values of the base layer as exponents of an exponentiation operation to determine the values of the medium transmission map.

In various embodiments, the determined medium transmission map may be modified using a compensation term, wherein the compensation term is adaptive to a haze degree of the input image. The scene radiances of the input image may be recovered based on the determined atmospheric light and the modified medium transmission map.

In various embodiments, the compensation term may be determined based on a histogram of the input image.

In various embodiments, the determined medium transmission map may be modified by further using a maximum value of the determined medium transmission map.

In various embodiments, the atmospheric light may be determined including selecting a pixel in the input image having highest intensity value; and determining the atmospheric light based on the selected pixel.

In various embodiments, the atmospheric light may be determined according to a hierarchical searching method. In the hierarchical searching method, the input image may be divided into a predetermined number of regions, and a value may be determined for each region by subtracting a standard deviation of pixel values within the region from an average pixel value of the region. A region with the highest value may be selected, and the above steps may be applied to the selected region iteratively until a size of the selected region is smaller than a pre-defined threshold. A pixel in the finally selected region having highest intensity value is selected, and the atmospheric light may be determined based on the selected pixel.

In various embodiments, the de-hazed image may be output, e.g. to a display for displaying the de-hazed image, or to a storage medium storing the de-hazed image.

Various embodiments of the image haze removal method are further described in more detail below.

Firstly, edge-preserving smoothing techniques are described below with the emphasis on the guided image filter (GIF) and the weighted guided image filter (WGIF).

The task of edge-preserving smoothing is to decompose an image X into two parts as follows:

X(p)=Z(p)+e(p) (1)

wherein Z is a reconstructed image formed by homogeneous regions with sharp edges, and may be referred to as a base layer. e is noise or texture, which may be composed of faster varying elements and may be referred to as a detail layer. p(=(x,y)) represents a position, e.g. the coordinates of a pixel.

One of the most popular edge-preserving smoothing techniques is based on local filtering. The bilateral filter (BF) is widely used due to its simplicity. However, the BF could suffer from “gradient reversal” artifacts which refer to the artifacts of unwanted sharpening of edges despite its popularity, and the results may exhibit undesired profiles around edges, usually observed in detail enhancement of conventional low dynamic range images or tone mapping of high dynamic range images. GIF was introduced to overcome this problem. In the GIF, a guidance image G is used which could be identical to the image X to be filtered. It is assumed that the reconstructed image Z is a linear transform of the guidance image G in a window Ω_{ζi}(p′):

Z(p)=a_{p′}G(p)+b_{p′}, ∀pϵΩ_{ζi}(p′) (2)

where Ω_{ζi} is a square window centered at the pixel p′ of a radius ζ₁. a_{p′} and b_{p′} are two constants in the window Ω_{ζi}(p′).

The values of a_{p′} and b_{p′} are then obtained by minimizing a cost function E(a_{p′},b_{p′}) which is defined as

$$E ( {a}_{{p}^{′}} , {b}_{{p}^{′}} ) = {\sum }_{p ∈ {Ω}_{{ζ}_{1}} ( {p}^{′} )} [ {( {a}_{{p}^{′}} G ( p ) + {b}_{{p}^{′}} - X ( p ) )}^{2} + λ {a}_{{p}^{′}}^{2} ] \qquad ( 3 )$$

wherein λ is a regularization parameter penalizing large a_{p′}. The value of λ is fixed for all pixels in the image.

Though the “gradient reversal” artifacts are overcome by the GIF, the GIF and the BF have a common limitation, i.e., they may exhibit halo artifacts near some edges where halo artifacts refer to the artifacts of unwanted smoothing of edges. An edge-aware weighting is incorporated into the GIF to form the WGIF. In human visual perception, edges provide an effective and expressive stimulation that is vital for neural interpretation of a scene. Larger weights are thus assigned to pixels at edges than pixels in flat areas. Let σ_{G,1}²(p′) be the variance of G in the 3×3 window Ω₁(p′). An edge-aware weighting Γ_{G}(p′) is defined by using local variances of 3×3 windows of all pixels as follows:

$${Γ}_{G} ( {p}^{′} ) = \frac{N ( {σ}_{G , 1}^{2} ( {p}^{′} ) + Ϛ )}{{\sum }_{p = 1}^{N} ( {σ}_{G , 1}^{2} ( p ) + Ϛ )} \qquad ( 4 )$$

wherein N is the total number of pixels in the image G. c is a small constant and its value is selected as (0.001×L)² while L is the dynamic range of the input image.

The weighting Γ_{G}(p′) in Equation (4) is incorporated into the cost function E(a_{p′},b_{p′}) in Equation (3). As such, the solution is obtained by minimizing a new cost function E(a_{p′},b_{p′}) which is defined as

$$E ( {a}_{{p}^{′}} , {b}_{{p}^{′}} ) = {\sum }_{p ∈ {Ω}_{{ζ}_{1}} ( {p}^{′} )} [ {( {a}_{{p}^{′}} G ( p ) + {b}_{{p}^{′}} - X ( p ) )}^{2} + \frac{λ}{{Γ}_{G} ( {p}^{′} )} {a}_{{p}^{′}}^{2} ] \qquad ( 5 )$$

WGIF can be applied to decompose the dark channel of a haze image into two layers as in Equation (1).

In the following paragraphs, a method of various embodiments to decompose dark channels of the haze image into two layers as in Equation (1) are described. The decomposition may be incorporated into the method of various embodiments for image haze removal.

A hazy image may be modelled by

X_{c}(p)=Z_{c}(p)t(p)+A_{c}(1−t(p)) (6)

wherein cϵ{r,g,b} is a colour channel index, X_{c} is a haze image, Z_{c} is a haze-free image, A_{c} is the global atmospheric light, and t is the medium transmission describing the portion of the light that is not scattered and reaches the camera.

The first term Z_{c}(p)t(p) may be referred to as direct attenuation, which describes the scene radiance and its decay in the medium. The second term A_{c}(1−t(p)) is referred to as air-light. Air-light results from previous scattered light and leads to the shift of the scene colour. When the atmosphere is homogenous, the medium transmission t(p) may be expressed as:

t(p)=e^{-αd(p)} (7)

wherein a is the scattering coefficient of the atmosphere. It indicates that the scene radiance is attenuated exponentially with the scene depth d(p). The value of a is a monotonically increasing function of the haze degree. It can be derived from Equation (7) that

0≤t(p)≤0.1 (8)

The objective of haze removal is to restore the haze-free image Z from the haze image X. This is challenging because the haze is dependent on the unknown depth information d(p) as in Equation (7). In addition, it is under-constrained as the input is only a single haze image while all the components A_{c}, t(p) and Z_{c} (p) are freedoms. To restore the haze-free image Z, both the global atmospheric light A_{c} and the medium transmission map t(p) need to be estimated. The haze-free image Z may be then restored as

$${Z}_{c} ( p ) = {X}_{c} ( p ) + ( \frac{1}{t ( p )} - 1 ) ( {X}_{c} ( p ) - {A}_{c} ) \qquad ( 9 )$$

It can be observed from the above equation that single image haze removal is a type of spatially varying detail enhancement. The amplification factor is (1/t(p)−1) which is spatially varying, and the detail layer is (X_{c}(p)−A_{c}). Instead of using a strong prior or assumption as in the existing haze removal methods, an edge-preserving decomposition technique is included in the method of various embodiments for the estimation of the transmission map t(p).

A haze image model may be first derived by using the dark channels of the haze image X and the haze-free image Z. Let Φ_{c}(⋅) represent a minimal operation along the colour channel {r,g,b}. Aₘ, Xₘ(p) and Zₘ(p) are defined as

Aₘ=Φ_{c}(A_{c})=min{Aᵣ,A_{g},A_{b}},

Xₘ(P)=Φ_{c}(X_{c}(p))=min{Xᵣ(p),X_{g}(p),X_{b}(p)},

Zₘ(p)=Φ_{c}(Z_{c}(p))=min{Zᵣ(p),Z_{g}(p),Z_{b}(p)}, (10)

Xₘ and Zₘ are referred to as the minimal colour components of the images X and Z, respectively.

Since the transmission map t(p) is independent of the colour channels r, g, and b, it can be derived from the haze image model in Equation (6) that the relationship between the minimal colour components Xₘ and Zₘ are given as

Xₘ(p)−Aₘ=(Zₘ(p)−Aₘ)t(p) (11)

Let Ψ_{ζ2}(⋅) represent a minimal operation in the neighborhood Ω_{ζ2}(p), and define it as

$${Ψ}_{{ζ}_{2}} ( z ( p ) ) = {min}_{{p}^{′} ∈ {Ω}_{{ζ}_{2}} ( p )} \{ z ( {p}^{′} ) \} \qquad ( 12 )$$

The dark channels of images X and Z, also referred to as simplified dark channels in this description, may be defined as Equation (13)

J_{d}^{Z}(p)Ψ_{ζ2}(Zₘ(p))

J_{d}^{X}(p)Ψ_{ζ2}(Zₘ(p)) (13)

wherein the value of ζ₂ may be a predetermined value, e.g., selected as 7 or any other suitable number to define the size of the neighborhood in which the minimal operation is carried out.

The dark channel or the simplified dark channel of a pixel may accordingly represent a minimum intensity value of a color component among all pixels in the predetermined neighborhood region of the pixel.

Since the value of t(p) is assumed to be constant in the neighborhood Ω_{ζ2}(p), it can be derived from Equation (11) that

J_{d}^{X}(p)−Aₘ=(J_{d}^{Z}(p)−Aₘ)t(p) (14)

The model in Equation (14) may be converted as

log₂(Ĵ_{d}^{X}(p))=log₂(t(p))+log₂(Ĵ_{d}^{Z}(p)) (15)

wherein Ĵ_{d}^{X}(p) and Ĵ_{d}^{Z}(p) are defined as |J_{d}^{X}(p)−Aₘ| and |J_{d}^{Z}(p)−Aₘ| respectively.

Since the transmission map t(p) is locally constant, i.e., its variation is slower than that of the dark channel Ĵ_{d}^{Z}. Under this assumption, log₂(t) represents the base layer formed by homogeneous regions with sharp edges, and log₂(Ĵ_{d}^{Z}) represents the detail layer composed of faster varying elements.

Once the values of the atmospheric light A_{c}(cϵ{r,g,b}) are determined, log₂ (Ĵ_{d}^{X}) can be derived from the input image X. The WGIF can then be applied to decompose the image log₂(Ĵ_{d}^{X}) into two layers as in Equation (15). Subsequently, the value of the transmission map t(p) may be determined.

According to various embodiments, a simple singe image haze removal method is provided by using the edge-preserving decomposition technique described above. The global atmospheric light A_{c}(cϵ{r,g,b}) may be first empirically determined by using a hierarchical searching method based on the quad-tree subdivision. The WGIF may be then adopted to decompose the simplified dark channel of a haze image into two layers as in Equation (15), and the value of t(p) may be then determined. Finally, the scene radiance Z(p) may be recovered by using the haze image model in Equation (6).

The global atmospheric light A_{c}(cϵ{r,g,b}) may be estimated as the brightest colour in a hazed image. Based on the observations that the variance of pixels values are generally small while the intensity values are large in bright regions, the values of A_{c}(cϵ{r,g,b}) may be determined by a hierarchical searching method based on the quad-tree subdivision.

In an embodiment, the input image is firstly divided into four rectangular regions. It is understood that the input image may also be divided into any other suitable number (e.g., 2, 6, 8 etc.) of regions in other embodiments. Each region is assigned a value which is computed as the average pixel value subtracted by the standard deviation of the pixel values within the region. The region with the highest value is then selected and it is furthered divided into four smaller rectangular regions. The process is repeated until the size of the selected region is smaller than a pre-defined threshold. In the finally selected region, the pixel which minimizes the difference ∥(Xᵣ(p),X_{g}(p),X_{b}(p))−(255,255,255)∥ (e.g. when the brightest white color has RGB values of (255, 255, 255)) is selected and the selected pixel is used to determine the global atmospheric light. In other embodiments wherein the white color is represented using other RGB intensity values, the above difference may be amended to be the difference from those other RGB values accordingly.

Once the values of A_{c}(cϵ{r,g,b}) are obtained, the value of Aₘ can be determined via Equation (10). The decomposition model in Equation (15) is available. The WGIF is applied to decompose the image log₂(Ĵ_{d}^{X}) into two layers as in Equation (15). The detail layer is log₂ (Ĵ_{d}^{Z}) and the base layer is log₂(t).

In the exemplary embodiments described herein, the guidance image and the image to be filtered are identical, and they are represented by log₂ (Ĵ_{d}^{X}). Similar to the Equation (2), it is assumed that log₂(t) is a linear transform of log₂(Ĵ_{d}^{X}) in the window Ω_{ζ1}(p′):

log₂(t(p))=a_{p′} log₂(Ĵ_{d}^{X}(p))+b_{p′}, ∀pϵΩ_{ζ1}(p′) (16)

It should be pointed out that the guidance image and the image to be filtered may be different in other embodiments. For example, the image to be filtered may be log₂(Ĵ_{d}^{X}) while the guidance image may be log₂ (|Aₘ−Xₘ|) in another embodiment. The equation (16) may be adapted accordingly to represent log₂(t) as a linear transform of the guidance image.

The values of a_{p′} and b_{p′} may be obtained by minimizing a cost function E(a_{p′},b_{p′}) which is defined as

$${\sum }_{p ∈ {Ω}_{{ζ}_{1}} ( {p}^{′} )} [ {( ( {a}_{{p}^{′}} - 1 ) {log}_{2} ( {\hat{J}}_{d}^{X} ( p ) ) + {b}_{{p}^{′}} )}^{2} + \frac{λ}{{Γ}_{{log}_{2} ( {\hat{J}}_{d}^{X} )} ( {p}^{′} )} {a}_{{p}^{′}}^{2} ] \qquad ( 17 )$$

where the values of ζ₁ and λ are set at 60 and 1/8, respectively.

The optimal values of a_{p′} and b_{p′} are computed as

$$\begin{matrix}{a}_{{p}^{′}}^{*} = \frac{{Γ}_{{log}_{2} ( {\hat{J}}_{d}^{X} )} ( {p}^{′} ) {σ}_{{log}_{2} ( {\hat{J}}_{d}^{X} ) , {ζ}_{1}}^{2} ( {p}^{′} )}{{Γ}_{{log}_{2} ( {\hat{J}}_{d}^{X} )} ( {p}^{′} ) {σ}_{{log}_{2} ( {\hat{J}}_{d}^{X} ) , {ζ}_{1}}^{2} ( {p}^{′} ) + λ} & ( 18 ) \\ {b}_{{p}^{′}}^{*} = ( 1 - {a}_{{p}^{′}}^{*} ) {{μ}_{{log}_{2}}}_{( {\hat{J}}_{d}^{X} ) , {ζ}_{1}} ( {p}^{′} ) & \end{matrix}$$

wherein μ_{1og} _{₂}_{(Ĵ}_{_{d}}_{^{X}}_{),ζ1}(p′) is the mean value of log₂(Ĵ_{d}^{X}) in the window Ω_{ζ1}(p′).

The optimal solution of the base layer log₂(t*(p)) is then given as follows:

log₂(t*(p))=āₚ*log₂(Ĵ_{d}^{X}(p))+b̅_{p′}* (19)

wherein āₚ* and b̅ₚ* are the mean values of a_{p′}* and b_{p′}* in the window Ω_{ζ1}(p), respectively.

The values of t*(p), i.e. the medium transmission map determined in the method of various embodiments above, may be then obtained through the 2^{(⋅)} operation.

The determined medium transmission map t*(p) may be further modified using a compensation term as in Equation (20) below

$${t}_{f}^{*} ( p ) = \frac{{t}^{*} ( p )}{{max}_{1 \leq {p}^{′} \leq N} \{ {t}^{*} ( {p}^{′} ) \}} \qquad ( 20 )$$

wherein t_{f}*(p) represents the modified medium transmission map. γ(≥1) represents a compensation term, which is a positive constant. The value of γ is adaptive to the input image X_{c}.

In various embodiments, a further modification term may be used to modify the medium transmission map, The further modification term may be used to set an upper limit for the medium transmission map. In various embodiments, a maximum value of the determined medium transmission map may be selected as the further modification term as in equation (20) above. In other embodiments, the minimum color component of the atmospheric light Aₘ may be selected as the further modification term. Other suitable values which may be used to set the upper limit for the medium transmission map may also be used in other embodiments.

It is noted that a non-negative sky region compensation term was introduced in [6] to adjust the value of the medium transmission map t(p) in the sky region according to the haze degree of the input image X_{c}. A similar compensation term γ is used in the embodiments of the method to modify the medium transmission map. The compensation term is adaptive to the haze degree of the input image X_{c}, which may be automatically detected by using the histogram of the image X_{c}. As such, halo artifacts can be reduced or avoided from appearing in the final image Z_{c}, and amplification of noise can be limited in the bright regions.

Once the values of the global atmospheric light A_{c}(cϵ{r,g,b}) and the transmission map t(p) are determined according to the embodiments above, the scene radiance Z(p) may be recovered by Equation (21) below

$${Z}_{c} ( p ) = \frac{1}{{t}_{f}^{*} ( p )} ( {X}_{c} ( p ) - {A}_{c} ) + {A}_{c} \qquad ( 21 )$$

According to the various embodiments above, a single image haze removal method is provided by introducing an edge-preserving decomposition technique for a haze image.

The method of various embodiments can be applied to process an input image which may be a hazy image including haze, and can also be applied to process a normal image without haze. In other embodiments, the method of various embodiments above can also be applied to underwater images that might be affected by underwater sediments so as to enhance underwater images, and can be applied to images of rain affected sceneries to enhance the features (e.g. landmarks) in the image covered by rain.

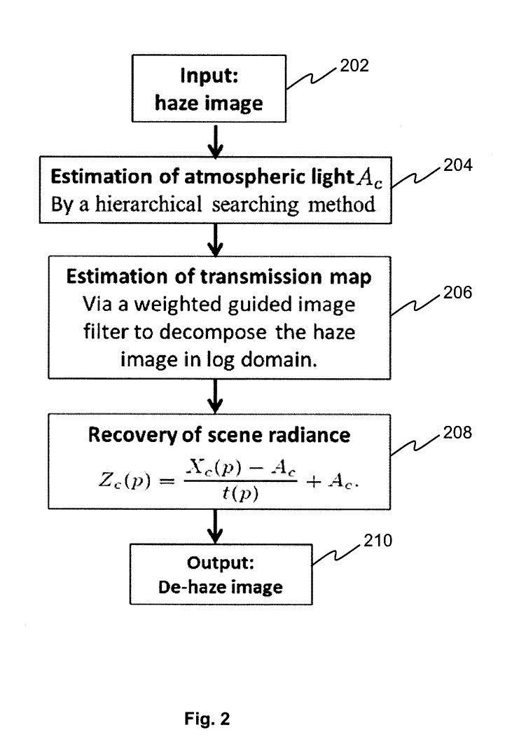

FIG. 2 shows a flow chart illustrating a method of processing an input image according to various embodiments.

An input image is received at 202. For example, a haze image is received.

An atmospheric light A_{c} is estimated at 204 by a hierarchical searching method.

In various embodiments, the estimation of the global atmospheric light may include dividing the input image into a predetermined number of rectangular regions, determining the value of each region by subtracting the standard deviation of the pixel values from the average pixel value in the region, selecting the region with the highest value and further dividing the selected region into the predetermined number of smaller regions. Repeating the above steps process until the size of the selected region is smaller than a pre-defined threshold, and selecting the pixel (that minimizes the difference from the intensity of a white color, e.g.) in the finally selected region as the global atmospheric light.

A transmission map is then estimated at 206 via a weighted guided image filter to decompose the haze image in log domain. It should be pointed out that the similar method also works in intensity domain with the log operation. It is understood that in other embodiments, other types of edge-preserving smoothing filter can also be used to decompose the haze image for determination of the transmission map.

In various embodiments, the base layer log₂(t*(p)) may be determined according to equation (19):

log₂(t*(p))=āₚ*log₂(Ĵ_{d}^{X}(p))+b̅_{p′}* (19)

wherein the coefficients a_{p′} and b_{p′} are determined using the weighted guided image filter according to equation (18) above. The dark channels J_{d}^{X}(p) may be determined according to equation (13) above, from which Ĵ_{d}^{X}(p) may be determined as |J_{d}^{X}(p)−Aₘ|.

Accordingly, the transmission map t*(p) may be determined using equation (19).

Scene radiances of the input image may be recovered based on the determined atmospheric light and the determined medium transmission map at 208, thereby generating the de-hazed image. The scene radiances may be determined according to the equation below which is similar to the equation (21) above.

In the scene radiance recovery at 208, the transmission map t(p) may be modified transmission map t_{f}*(p) according to equation (20), and the modified transmission map is used to recover the scene radiances. In modifying the transmission map, an adaptive lower bound is predefined for the transmission map to limit the amplification factor, wherein a large lower bound introduces less noise but retains more haze in the image, while a smaller lower bound introduces more noise in the image but haze is removed substantially.

The de-hazed image is then output at 210, for example, to a display.

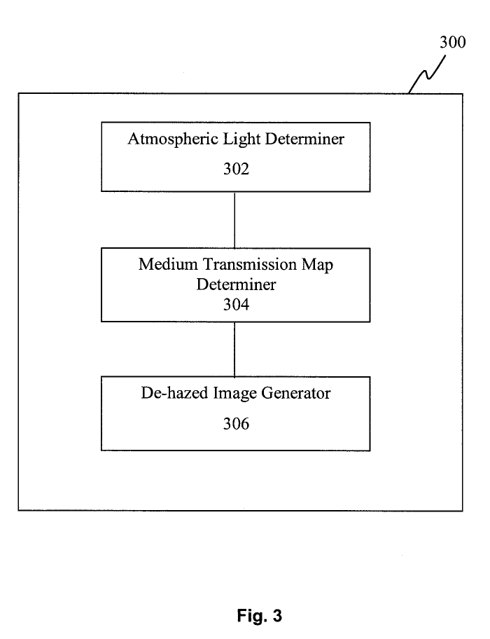

FIG. 3 shows a schematic diagram of an image processing device 300 according to various embodiments.

The image processing device 300 may include an atmospheric light determiner 302 configured to determine an atmospheric light based on the input image.

The image processing device 300 may include a medium transmission map determiner 304 configured to determine a medium transmission map by applying an edge-preserving smoothing filter to the input image.

The image processing device 300 may further include a de-hazed image generator 306 configured to recover scene radiances of the input image based on the determined atmospheric light and the determined medium transmission map, wherein the recovered scene radiances form the de-hazed image.

In various embodiments, the edge-preserving smoothing filter may include one of a guided image filter (GIF), a weighted guided image filter (WGIF), a gradient domain guided image filter or a bilateral filter (BF).

In various embodiments, the medium transmission map determiner 304 is configured to determine dark channels of the input image; determine a base layer of the input image from the dark channels using the edge-preserving smoothing filter; and determine the medium transmission map based on the base layer.

In various embodiments, the medium transmission map determiner 304 is configured to, for each pixel of the input image, determine minimal intensity color components of pixels in a predetermined neighborhood of the pixel, and determine the dark channel of the pixel to be a minimum intensity among the determined minimal intensity color components.

In various embodiments, the medium transmission map determiner 304 is configured to determine a plurality of coefficients using the edge-preserving smoothing filter; and determine the base layer of the input image based on the dark channels of the input image, the corresponding coefficients and the determined atmospheric light. The plurality of coefficients may be a_{p′} and b_{p′} determined using the weighted guided image filter according to equation (18) above.

In various embodiments, the medium transmission map determiner 304 is configured to derive the medium transmission map from the base layer, for example using values of the base layer as exponents of an exponentiation operation to obtain the values of the medium transmission map.

In various embodiments, the image processing device 300 may further include a medium transmission map modifier configured to modify the determined medium transmission map using a compensation term, wherein the compensation term is adaptive to a haze degree of the input image. The de-hazed image generator 306 is configured to recover scene radiances of the input image based on the determined atmospheric light and the modified medium transmission map.

The medium transmission map modifier may be provided as a separate determiner in the image processing device 300, or may be incorporated in the medium transmission map determiner 304.

In various embodiments, the medium transmission map modifier may be configured to determine the compensation term based on a histogram of the input image.

In various embodiments, the medium transmission map modifier may be configured to modify the determined medium transmission map using a further modification term. The further modification term may be used to set an upper limit for the determined medium transmission map. The further modification term may be, for example Aₘ or the maximum value of the medium transmission map as in Equation (20).

In various embodiments, the atmospheric light determiner 302 is configured to select a pixel in the input image having highest intensity value; and determine the atmospheric light based on the selected pixel.

In various embodiments, the atmospheric light determiner 302 is configured to divide the input image into a predetermined number of regions; determine a value for each region by subtracting a standard deviation of pixel values within the region from an average pixel value of the region; select a region with the highest value; repeat the above steps for the selected region iteratively until a size of the selected region is smaller than a pre-defined threshold; select a pixel in the selected region having highest intensity value; and determine the atmospheric light based on the selected pixel.

The image processing device 300 may be configured to carry out the method of various embodiments as described above. It should be noted that embodiments described in context with the methods above are analogously valid for the image processing device 300 and vice versa.

The components of the image processing device 300 (e.g. the atmospheric light determiner 302, the medium transmission map determiner 304 and the de-hazed image generator 306) may for example be implemented by one or more circuits. A “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit”.

Although the determiners 302, 304 and the generator 306 are shown as separate components in FIG. 3, it is understood that the image processing device 300 may include a single processor configured to carry out the processes performed in the determiners 302, 304 and the generator 306.

In other embodiments, the image processing device 300 may be or may include a computer program product, e.g. a non-transitory computer readable medium, storing a program or instructions which when executed by a processor causes the processor to carry out the methods of various embodiments above.

According to various embodiments, a non-transitory computer readable medium with a program stored thereon for processing an input image to generate a de-hazed image is provided. The program when executed by a processor causes the processor to determine an atmospheric light based on the input image; determine a medium transmission map by applying an edge-preserving smoothing filter to the input image; and recover scene radiances of the input image based on the determined atmospheric light and the determined medium transmission map. The recovered scene radiances form the de-hazed image.

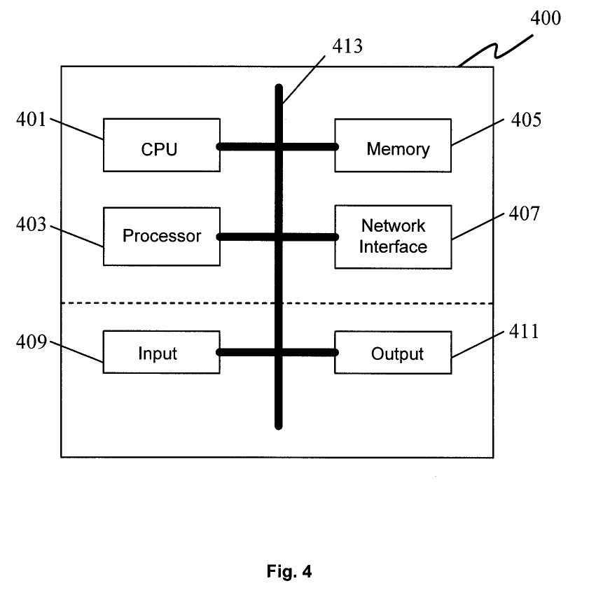

FIG. 4 shows a schematic diagram of an image processing device 400 according to various embodiments.

The image processing device 400 may be implemented by a computer system. In various embodiments, the atmospheric light determiner 302, the medium transmission map determiner 304 and the de-hazed image generator 306 may also be implemented as modules executing on one or more computer systems. The computer system may include a CPU 401 (central processing unit), a processor 403, a memory 405, a network interface 407, input interface/devices 409 and output interface/devices 411. All the components 401, 403, 405, 407, 409, 411 of the computer system 400 are connected and communicating with each other through a computer bus 413.

The memory 405 may be used as for storing input images, the determined atmospheric light, the determined transmission map, the modified transmission map, and the de-hazed images used and determined according to the method of the embodiments. The memory 405 may include more than one memory, such as RAM, ROM, EPROM, hard disk, etc. wherein some of the memories are used for storing data and programs and other memories are used as working memories.

In an embodiment, the memory 405 may be configured to store instructions for processing an image according to various embodiments above. The instructions, when executed by the CPU 401, may cause the CPU 401 to determine an atmospheric light based on the input image; determine a medium transmission map by applying an edge-preserving smoothing filter to the input image; and recover scene radiances of the input image based on the determined atmospheric light and the determined medium transmission map. The instruction may also cause the CPU 401 to store input images, the determined atmospheric light, the determined transmission map, the modified transmission map, and the de-hazed images determined according to the method of the embodiments in the memory 405.

In another embodiment, the processor 403 may be a special purpose processor, in this example, a image processor, for executing the instructions described above.

The CPU 401 or the processor 403 may be used as the image processing device as described in various embodiments below, and may be connected to an internal network (e.g. a local area network (LAN) or a wide area network (WAN) within an organization) and/or an external network (e.g. the Internet) through the network interface 407.

The Input 409 may include a keyboard, a mouse, etc. The output 411 may include a display for display the images processed in the embodiments below.

As single image haze removal can be regarded as a type of spatially varying detail enhancement, a single image haze removal method is provided by introducing an edge-preserving decomposition technique for a haze image. The simplified dark channel of the haze image is decomposed into a base layer and a detail layer by using the weighted guided image filter (WGIF). The base layer is formed by homogeneous regions with sharp edges and the detail layer is composed of faster varying elements. The transmission map is estimated from the base layer. To avoid amplifying noise in the haze image, an adaptive compensation term is proposed to constrain the value of the transmission map, especially in the bright regions. This is different from the conventional haze removal methods in which a fixed lower bound is used. The estimated transmission map is finally used to recover the haze image.

The haze removal method according to various embodiments can avoid or reduce halo artifacts, noise in the bright regions, and colour distortion from appearing in the de-hazed image. In addition, a very small amount of haze is retained for the distant objects by the proposed haze removal method. As a result, the perception of distance in the de-hazed image could be preserved better. Experimental results show that the method is applicable to different types of images such as haze images, underwater images and normal images without haze. The method of various embodiments offers a framework for single image haze removal, which does not require the strong dark channel priori as required by the single image haze removal methods in conventional methods. The method of various embodiments can be applied to achieve better image quality, and is at the same time friendly to mobile devices with limited computational resource.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of processing an input image to generate a de-hazed image, the method comprising:
determining an atmospheric light based on the input image;
determining a medium transmission map by applying an edge-preserving smoothing filter to the input image; and
recovering scene radiances of the input image based on the determined atmospheric light and the determined medium transmission map, wherein the recovered scene radiances form the de-hazed image.

2. The method according to claim 1, wherein determining the medium transmission map comprises:
determining dark channels of the input image;
determining a base layer of the input image from the dark channels using the edge-preserving smoothing filter; and
determining the medium transmission map based on the base layer.

3. The method according to claim 2, wherein determining the base layer comprises:
determining a plurality of coefficients using the edge-preserving smoothing filter; and
determining the base layer of the input image based on the dark channels of the input image, the plurality of coefficients and the determined atmospheric light.

4. The method according to claim 2, wherein determining the medium transmission map comprises:
deriving the medium transmission map from the base layer using values of the base layer as exponents of an exponentiation operation.

5. The method according to claim 1, further comprising:
modifying the determined medium transmission map using a compensation term, the compensation term being adaptive to a haze degree of the input image; and
recovering scene radiances of the input image based on the determined atmospheric light and the modified medium transmission map.

6. The method according to claim 5, wherein the compensation term is determined based on a histogram of the input image.

7. The method according to claim 1, wherein the edge-preserving smoothing filter comprises one of a guided image filter, a weighted guided image filter, a gradient domain guided image filter, and a bilateral filter.

8. The method according to claim 1, further comprising:
outputting the de-hazed image.

9. An image processing device for processing an input image to generate a de-hazed image, the device comprising:
an atmospheric light determiner configured to determine an atmospheric light based on the input image;
a medium transmission map determiner configured to determine a medium transmission map by applying an edge-preserving smoothing filter to the input image; and
a de-hazed image generator configured to recover scene radiances of the input image based on the determined atmospheric light and the determined medium transmission map, wherein the recovered scene radiances form the de-hazed image.

10. The image processing device according to claim 9, wherein the medium transmission map determiner is configured to:
determine dark channels of the input image;
determine a base layer of the input image from the dark channels using the edge-preserving smoothing filter; and
determine the medium transmission map based on the base layer.

11. The image processing device according to claim 10, wherein the medium transmission map determiner is configured to:
determine a plurality of coefficients using the edge-preserving smoothing filter; and
determine the base layer of the input image based on the dark channels of the input image, the plurality of coefficients and the determined atmospheric light.

12. The image processing device according to claim 10, wherein the medium transmission map determiner is configured to derive the medium transmission map from the base layer using values of the base layer as exponents of an exponentiation operation.

13. The image processing device according to claim 9, further comprising
a medium transmission map modifier configured to modify the determined medium transmission map using a compensation term, the compensation term being adaptive to a haze degree of the input image;
wherein the de-hazed image generator is configured to recover scene radiances of the input image based on the determined atmospheric light and the modified medium transmission map.

14. The image processing device according to claim 13, wherein the medium transmission map modifier is configured to determine the compensation term based on a histogram of the input image.

15. The image processing device according to claim 9, wherein the edge-preserving smoothing filter comprises one of a guided image filter, a weighted guided image filter, a gradient domain guided image filter, and a bilateral filter.

16. The image processing device according to claim 9, further comprising an output configured to output the de-hazed image.

17. A non-transitory computer readable medium with a program stored thereon for processing an input image to generate a de-hazed image, the program when executed by a processor causes the processor to:
determine an atmospheric light based on the input image;
determine a medium transmission map by applying an edge-preserving smoothing filter to the input image;
recover scene radiances of the input image based on the determined atmospheric light and the determined medium transmission map, wherein the recovered scene radiances form the de-hazed image.
